(19) United States
(12) Patent Application Publication
(10) Pub. No.: US 2013/0193176 A1
(43) Pub. Date: Aug. 1, 2013

(54) Securing Apparatus for a Roof Rack

(71) Applicant: Denis Khoo, Arcadia, CA (US)

(72) Inventor: Denis Khoo, Arcadia, CA (US)

(21) Appl. No.: 13/752,391

(22) Filed: Jan. 29, 2013

Related U.S. Application Data
(60) Provisional application No. 61/593,812, filed on Feb. 1, 2012.

(51) Int. Cl. B60R 9/08

(52) U.S. Cl. CPC B60R 9/08
USPC 224/324

(57) ABSTRACT

Method and apparatus for securing an object onto a roof rack. The method and apparatus utilizes a securing arm to rotate and press an object onto a roof rack. The securing arm is held in a closed position to keep the object securely pressed onto a roof rack. The method and apparatus provides a more convenient and secure means of securing an object onto a roof rack.

This patent application claims the benefit of, priority of, and incorporates by reference U.S. Provisional Patent Application Ser. No. 61/593,812, entitled “Equipment Securing Apparatus for a Vehicle Load Carrier” by Denis Khoo filed on Feb. 1, 2012.

### FIELD OF THE INVENTION

The invention relates to an apparatus for securing objects to a roof rack, and more specifically, an apparatus with a rotating arm for securing objects to a roof rack.

### DESCRIPTION OF RELATED ART

Objects that do not fit or are not desired to be in a vehicle are typically secured outside the vehicle for transport. Some examples of such objects include sports equipment like a surfboard, stand up paddle board, body board, kayak, snow sled, and so on. Other objects may include utility equipment, such as a ladder, or cargo. These objects are often attached to a load carrier (or cargo carrier), such as a roof rack or a truck rack.

Roof racks and truck racks are popular on many vehicles, and are known for use in conjunction with carrying and securing objects on top of the vehicle. A roof rack can found on the roof of a vehicle. A truck rack can be found on a pickup truck, and is very much like a roof rack, except it is above the truck bed. Both a roof rack and truck rack will be referred to as simply a roof rack. A roof rack is generally comprised of a set of rails that are laid out on either side of the vehicle and go from the front to the rear. Generally, there are at least two crossbars, and each crossbar attaches in between the two rails and are perpendicular to the rails. The distance between crossbars can usually be adjusted. It is also possible that a vehicle may be equipped with a set of crossbars without the use of rails, in which case, the crossbars will have feet to attach directly to the roof of the vehicle. These and other variations of roof racks are well known in the industry and to those skilled in the art.

Crossbar clamps are utilized to clamp on various types of securing apparatus to the crossbars of a roof rack. For example, a ski/snowboard securing apparatus, will attach to a set of crossbar clamps, and these crossbar clamps will be securely clamped to the roof rack's crossbars. The primary reason crossbar clamps exists and are not built into the securing apparatus is because crossbars come in various shapes and sizes. These crossbar clamps may be fitted to a particular brand or style of crossbar, and more recently, they may be of universal fit, meaning they may be compatible with many brands and styles of crossbars. A popular example of a universal crossbar clamp can be seen in U.S. Pat. No. 7,357,283. It is thus possible to remove one type of securing apparatus, and replace it with a different securing apparatus to a particular roof rack, while using the same crossbar clamps. For example, someone with a ski/snowboard securing apparatus may replace it with a surfboard securing apparatus using the same roof rack and crossbar clamps.

For water sports, such as surfing or stand up paddle boarding, there are a variety of products that can be used to secure a surfboard or paddleboard onto a vehicle. Generally for surfboard and paddleboards, pads are used on the crossbars, and the board is placed on these pads. Then the board is strapped down to the roof rack using conventional strap ties or ratchet straps. Using straps creates a burden and inconvenience because it may take some time to strap and unstrap. Also, depending on the quality of the straps and latch (or buckle) that secures the straps, the objects being held may not be truly stable and secure. There are a few products on the market that aid in trying to make it more convenient to secure surfboards. They include the Thule Hang Two Surf Carrier and the Inno BoardLocker Board Rack. Both of these, though far better than using just straps, still rely on some form of straps and padding. Some of these products offer the ability to lock the latch, which prevents the latch from accidentally coming loose, and prevents theft of the secured objects. However, since straps are relied upon, it may be an easy task for a thief to simply cut the straps.

There is a need to provide a more convenient, more secure, and safer means of securing large shaped objects capable of being laid down easily, such as surfboards and paddleboards, onto a roof rack.

### BRIEF SUMMARY OF THE INVENTION

An apparatus for securing an object to a vehicle's roof rack is described. In some embodiments, the securing apparatus is attached to a crossbar of a roof rack, and has a securing arm that may rotate. The securing arm may rotate and its rotation position may be set and held. Two of the securing arm's rotation position are the open position and secured position. In the open position, the securing arm allows for the object to be placed on the roof rack, and while the object is on the roof rack, the securing arm may be rotated to the secured position, thereby coming in contact with the object to tightly secure it onto the vehicle's roof rack.

In accordance with some embodiments, the securing arm rotates via the settable rotational mechanism. The settable rotational mechanism allows for the securing arm to be set and held at various rotational positions. In a preferred embodiment, the means of setting and holding is performed using a ratchet mechanism. With the ratchet mechanism, the securing arm is held and prevented from loosening its hold on the object. The securing arm may apply inward and downward force on the object to optimally secure the object onto the roof rack.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a perspective view of a preferred embodiment of the securing apparatus.

FIG. 2 is a right side view of a preferred embodiment of the securing apparatus.

FIG. 3 is a top view of a preferred embodiment of the securing apparatus.

FIG. 4 is a bottom view of a preferred embodiment of the securing apparatus.

FIG. 5 is a front view of a preferred embodiment of the securing apparatus.

FIG. 6 is an exploded view of a preferred embodiment of the securing apparatus.

FIG. 7 is a perspective view of a preferred embodiment of the securing apparatus in the secured position on a vehicle roof rack utilized to secure a surfboard.

FIG. 8 is a perspective view of a preferred embodiment of the securing apparatus in the open position on a vehicle roof rack.

FIG. 9a is a graph showing positive angles.

FIG. 9b is a graph showing negative angles.

### DETAILED DESCRIPTION

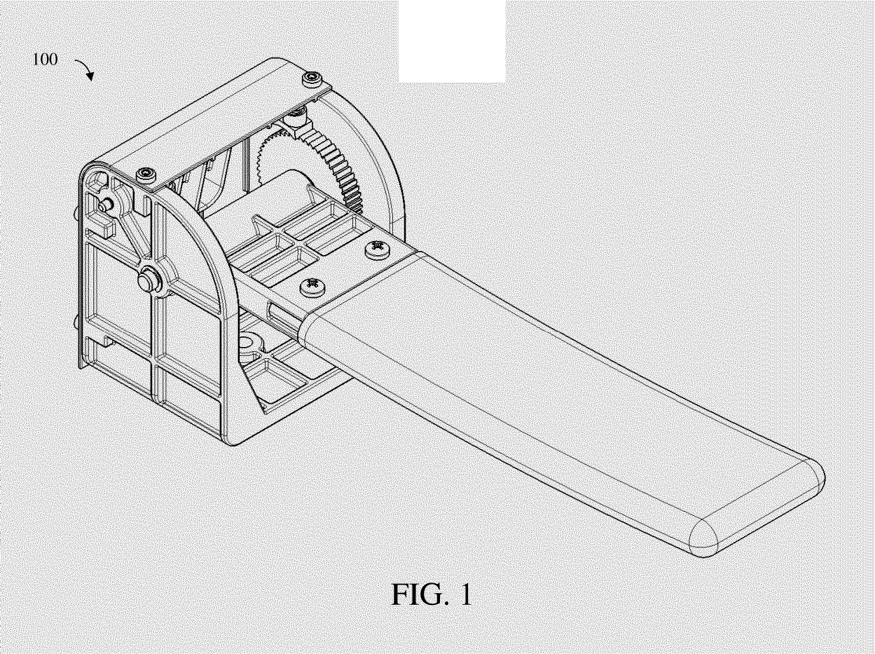

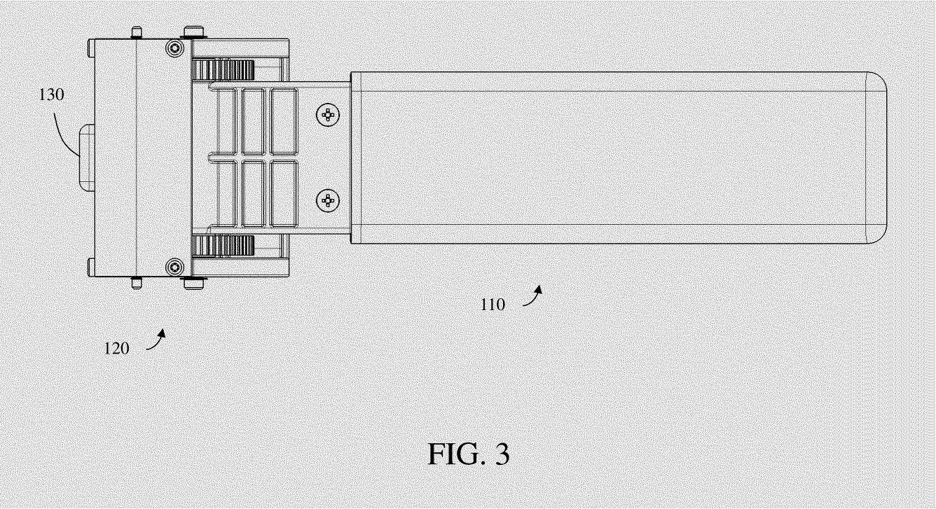

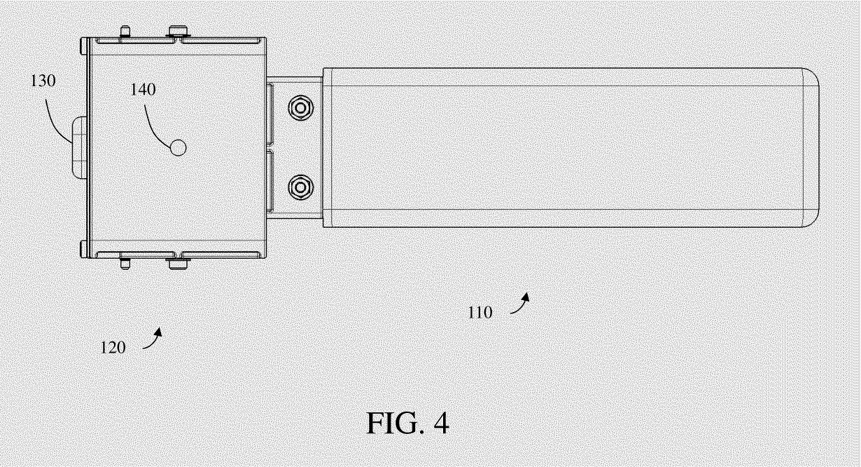

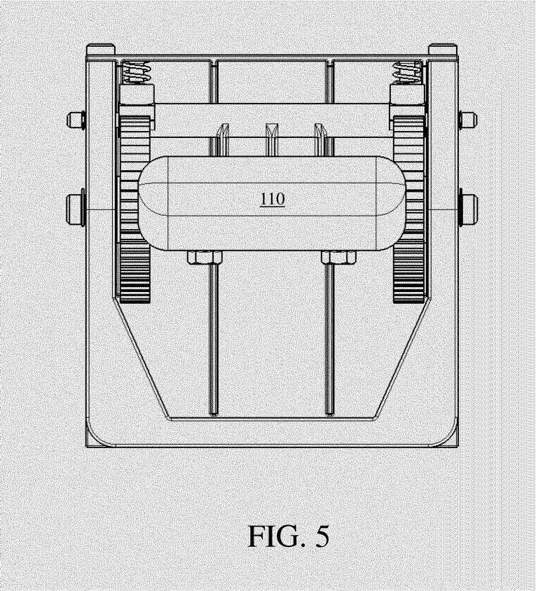

FIGS. 1-5 show a preferred embodiment of a securing apparatus 100. The securing apparatus 100 is generally designed to be attached to a vehicle's roof rack. The securing apparatus 100 is comprised of a housing 120 and rotating arm 110. As is conventional with most securing apparatus, the securing apparatus 100 attaches to the crossbar of a vehicle's roof rack via a crossbar clamp. The housing 120 covers the settable rotational mechanism for both aesthetics and protection from the elements. The settable rotational mechanism sits inside the housing 120, and is attached to the securing arm 110. The securing arm 110 protrudes outside of the housing 120. The settable rotational mechanism allows the securing arm 110 to rotate along an axis in the housing 120. In other embodiments, the axis may be outside of the housing 120. The settable rotational mechanism can be set and held in the open or secured position.

In one example, the securing apparatus of this embodiment may be used to secure a surfboard on the vehicle's roof rack. The surfboard is laid down on the two crossbars, which has a conventional form of compressible padding between the surfboard and the crossbars. Conventional padding that wraps around a crossbar is comprised of foam wrapped by nylon or some other type of material. It is preferred that the compressible padding have some form of tacky material, such as rubber, EVA, silicone, elastic foam, or neoprene, where it comes into contact with the surfboard or other objects. Generally, the surfboard is placed upside down, and since the top of the surfboard is tacky to prevent the surf rider from slipping (either by wax or other type of traction), this helps to provide some form of tackiness. Another type of compressible padding between the crossbar and the object is the Thule “Hang-Two Surf Carrier” which holds a surfboard at the edges, and allows those surfboard edges to lie on compressible padding.

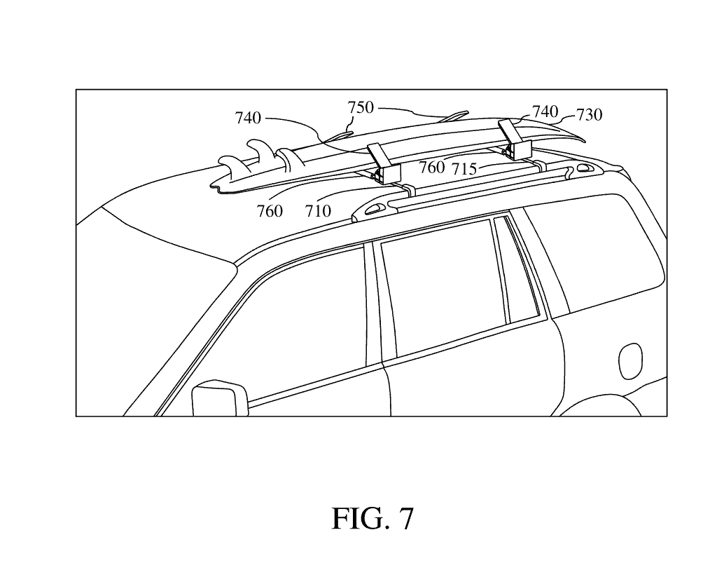

FIG. 7 shows the securing apparatus of the preferred embodiment on a vehicle where it is utilized to secure a surfboard onto the roof of the vehicle. The securing apparatuses 740 750 are placed on either side of the surfboard 730 on each crossbar 710 715. The securing apparatuses 740 may be held onto the crossbars 710 715 using crossbar clamps. The surfboard 730 may lie on a compressible padding 760 wrapped around the crossbars 710 715. In the preferred embodiment, the top of the surfboard 730 will be higher than the rotational axis point of the settable rotational mechanism in the securing apparatuses 740 750. Each of the four securing apparatuses 740 750 will be used to securely hold down the surfboard 730 by pressing it between the crossbars 710 715 and the securing arms 740 750.

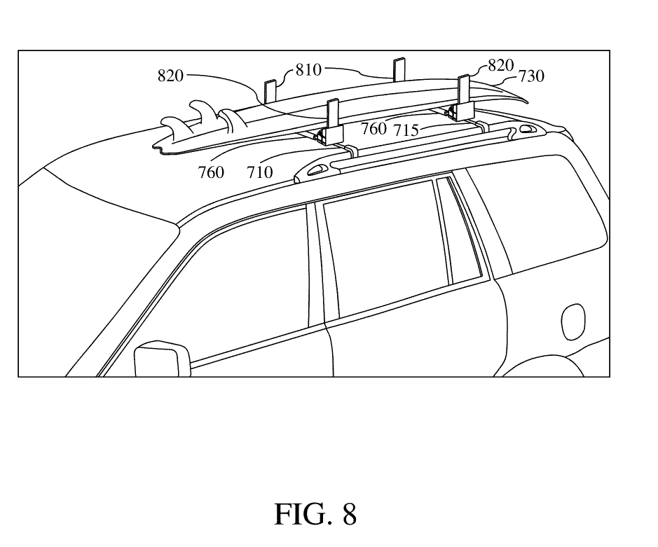

As demonstrated in FIG. 8, the securing arm begins in the open position 810 820 to allow the surfboard 730 to be placed between the securing apparatuses 810 820. This open position usually means the securing arm is rotated so it is pointing directly up, or outward from the surfboard. After the surfboard 730 has been placed (directly or indirectly) on the crossbars 710 715, between the securing apparatuses 810 820 in the open position, each of the securing apparatuses can be placed in the secured position. The secured position is shown in FIG. 7. This is done by rotating the arm towards the surfboard 730 (also referred to as rotating the arm towards the secured position) until there is adequate force applied between the securing arm and respective crossbar. Once in the secured position, the arm is set and held in place (through the settable rotational mechanism), and may not be rotated towards the open position.

In the preferred embodiment of FIGS. 1-5, the securing arm 110 is comprised of a hard plastic core wrapped by a rubberized material on the outside. It is preferable to utilize a compressible material, such as rubber, foam, EVA, neoprene, or silicone, where the securing arm 110 comes into contact with the object. The area where the securing arm 110 comes into contact with the object is referred to as the securing arm contact area. This compressible material helps to ensure a snug hold while preventing damage to the object. It is also preferred that the securing arm 110 utilizes a tacky material where it comes into contact with the object to prevent the object from sliding.

In some embodiments, it is preferred that the securing arm 110 have a flat width (of at least 1 inch) to come in contact with the object, which increases the surface area at the securing arm contact area. A small surface area for the securing arm contact area may not be desirable as it may result in more force to a smaller area that could result in damage to the object. An example of an object that may be easily damaged is a surfboard or paddleboard. Thus, in some embodiments, it is preferred that the securing arm have a generally flat section with a width of at least 1 inch where the securing arm comes in contact with the object. In other embodiments, a wide flat width may not be necessary or desirable. For example, if the object being secured is not prone to damage, then an increased securing arm contact area may not be necessary. An example of an object that may not be easily damaged is a ladder.

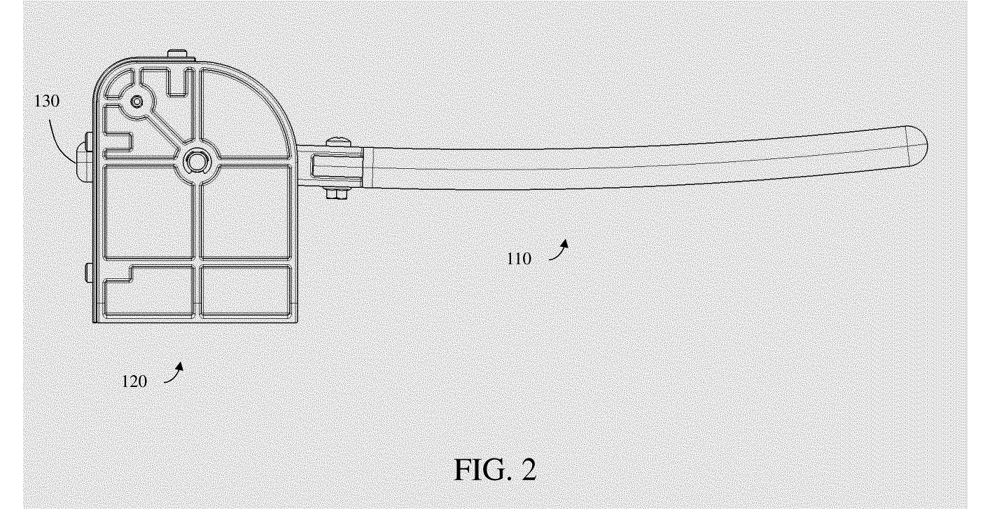

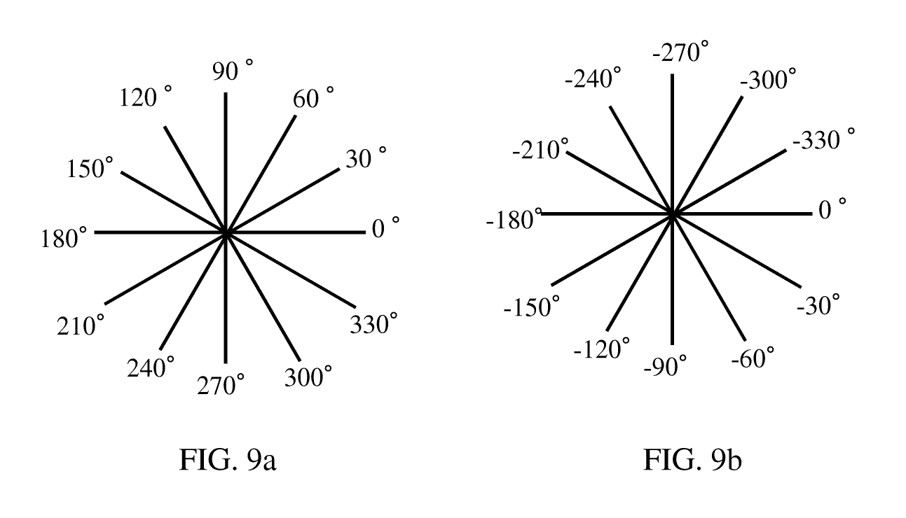

Due to the rotational nature of the securing arm 110, the securing arm may be rotated to the open position or close position. The open position refers to a rotational position of the securing arms that allow for the release and removal of the object. The secured position refers to a rotational position of the securing arms that secures the object, preventing removal of the object from the roof rack. The rotational position can best be described in a two dimensional Cartesian coordinate system. The securing apparatus is viewed from the right side (FIG. 2) when determining it's rotational position. Both positive angles and negative angles may be used to denote the position of the arm, as shown in FIG. 9a and FIG. 9b respectively. When the securing arm is flat along the horizontal, it is essentially along the x-axis (between quadrants I and IV) where θ, or the rotational position is 0°. When the securing arm is straight up, it is essentially along the y-axis where θ, or the rotational position is 90°. If the securing arm is at 0° and is rotated clockwise, it will reach −1°, follow by −2°, and so on. Once it reaches the rotational position −90°, it is essentially pointing straight downwards.

FIG. 7 shows an embodiment of the securing arms in the secured position. In this preferred embodiment, the securing arms contact area is at a higher elevation than the rotational axis point. As a result, the securing arms reach a secured position and come into contact with the object at a rotational position between 0° and 90°. At these angles there is both horizontal (inward) and vertical (downward) force being applied on the object from the four securing arms. The inward force on the object is applied from the two opposing securing arms, thus wedging the object in between the two securing arms. The downward force wedges the object between the securing arm and the crossbar (or crossbar padding). These combined forces prevent the object from moving in any direction. Also, any tackiness between the object and securing arms, along with any tackiness between the object and the crossbars will assist in preventing movement of the object.

The open position may generally be considered a rotational position between 90° and 180°. In the open position, the object can be easily placed on and taken off the roof rack.

The securing arm may also be in the hideaway position. The hideaway position is utilized when there is no object on the roof rack. The hideaway position is generally around 0° or 180°, where the securing arm can be most out of sight. This can be advantageous for aerodynamics as well as aesthetic purposes.

It is preferred that four securing apparatuses, each with settable rotational mechanisms are used to secure an object. However, it should be noted that at most, one securing apparatus is required. In one embodiment, the securing arm of one securing apparatus may hold down one side of an object, while the other side of the object may be held down by other means. For example, a stationary, non-rotatable securing arm permanently at the 45° angle may be attached to the crossbar on the other side of the object. The use of fewer securing apparatuses may be desirable for cost purposes.

As mentioned earlier, the settable rotational mechanism (and thus the attached securing arm) can be set and held in various rotational positions, such as the closed or open position. There are many means for setting and holding the settable rotational mechanism. One means of setting and holding the rotational position of the settable rotational mechanism is through a clamping mechanism that may be tightened to prevent further rotation. Another means of setting and holding the rotational position of the securing arm is by latching at various rotational angles. For example, one means of latching is by having a pin hole that holds a rotational position in place when a pin is in the hole. The pin hole may be designed such that the rotational position is held and cannot be moved towards the open or secured position, or may be designed such that the rotational position can be moved further towards the secured position, but not the open position. There may be multiple pin holes for the various rotational positions. For example, in one embodiment, there may be pin holes for the following rotational positions: −10°, 0°, 10°, 20°, 30°, 40°, 50°, 60°, 70°, 80°, 90°, and 100°. The pin may be spring loaded, to allow the pin to be pulled out of the pin hole by force, and to automatically go back into the pin hole when released. Another means for setting and holding a rotational position is a ratchet system that allows for the securing arm to be rotated towards the secured position, and will be set and held against rotating towards the open position at each step in the ratchet rotation. The ratchet is comprised of a gear with teeth that engage a pawl, preventing the securing arm from rotating towards the open position. A ratchet can allow for linear or rotary motion in one direction while preventing motion in the opposite direction, and it's general usage, variations, and features are well known to those skilled in the art.

Smaller angular increments between rotational positions is preferred to ensure that the best rotational position may be utilized depending on the object. It is preferred that the increments between rotational positions be 5° or less. Also, it should be noted that the angular difference between consecutive rotational positions need not always be the same. For example, an embodiment of a securing apparatus might have support for these rotational positions: 0°, 10°, 15°, 22°, 50°, and 90°.

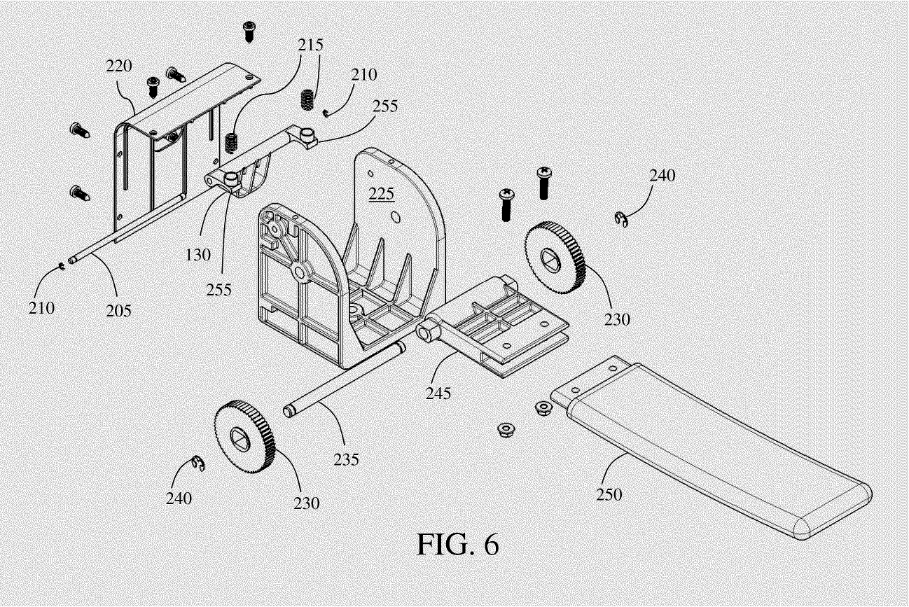

The preferred embodiment utilizes a ratchet for setting the securing arm. FIG. 6 shows an exploded view of the preferred embodiment. The two main components relevant to the ratchet in FIG. 6 are the double pawls 255 and the gears with teeth 230. The gears 230 are fixedly attached to the securing arm base 245. The gears rotate along with the securing arm 250. The double pawls 255 come into contact with the gears 230 to form the fundamentals of a ratchet, allowing for rotation towards the close position, but preventing rotation towards the open position. The double pawls 255 with a release mechanism 130 is mounted to the housing frame 225 via a rod 205, which allows the double pawls 255 to be lifted (and thus disengaged) from the gears when the release 130 is pressed. The pawl springs 215 ensure that the pawl is engaged with the gears 230 whenever the release mechanism 130 is not being pressed. The release mechanism 130, when pressed, disengages the double pawls 255 from the gears 230, thus allowing the securing arm 250 to be rotated towards the open position. Other embodiments may utilize other means for the release mechanism rather than a button, such as a lever or switch. In other embodiments, the release mechanism may disengaging the pawl from the gear teeth would be by moving the gear away from the pawl. This would achieve a similar affect and allow the gear to rotate freely. There are many other means of disengaging the pawl from the gear teeth for a release mechanism, which are well known to those skilled in the art. Another example is in U.S. Pat. No. 5,478,341, which is incorporated herein by reference.

The ratchet may have a ratchet locking mechanism to entirely prevent the disengaging of the pawl from the gear. This could be used for anti-theft purposes. A key lock can be utilized to place the ratchet locking mechanism in the locked position, which would prevent the release mechanism from functioning. For example if the release mechanism functions by pressing a button, which lifts the pawl off the gear teeth, the ratchet locking mechanism could have a rigid blocking plate which goes over the pawl when in the locked position, preventing the pawl from being lifted, thus rendering the release button inoperative.

Also, since the securing apparatus is mounted onto the crossbars via crossbar clamps, it may be important for anti-theft purposes that these crossbar clamps cannot be easily removed. It is well known in the industry that there are several different forms of crossbar clamps that are anti-theft. A popular form of anti-theft protection for the crossbar clamp is by designing the crossbar clamps such that it cannot be removed from the crossbars unless the securing apparatus has been removed first from the crossbar clamps first.

As seen in FIG. 6, the securing arm 250 attaches to a securing arm base 245. In the preferred embodiment, the securing arm 250 can be replaced to accommodate various types of securing arms. In other embodiments, the securing arm may be permanently attached and not replaceable. Various styles of securing arms may be beneficial for various objects. The securing arm 250 of the preferred embodiment is wide and flat, with a slight upward curvature as it extends outward. The upward curvature has the advantage of allow the securing arm to also function well when the securing arm contact area is at a lower elevation than the rotational axis point. In general, if the securing arm contact area is at a lower elevation than the rotational axis point, then the rotation angle is likely between 0° and −90°. Through the upward curvature in the securing arm, there is a higher likelihood of the securing arm contact area not being at the tip of the securing arm. This promotes more surface area contact and better secures the object between the securing arm and the crossbar. In addition, the end (or tip) of the securing arm has rounded corners. This is advantageous in case the securing arm contact area is at the tip, in which case, the rounded corners will help improve the contact area and prevent damage to the object.

In another embodiment, the securing arm could have a high degree of downward curvature. This may be advantageous for the intentional purpose of having the tip of the securing arm enter into a groove on the object. For example, a ladder has large grooves between steps, and a downward curvature would intentionally allow the tip of the securing arm to enter a groove, enhancing the securing of the object to the roof rack. It is also possible that objects are designed with special grooves for the express intent of being compatible with a securing arm.

The present invention has been described in an illustrative manner. It is to be understood that the terminology which has been used is intended to be in the nature of words of description rather than of limitation. While there have been described herein, what are considered to be preferred and exemplary embodiments of the present invention, other modifications of the invention shall be apparent to those skilled in the art from the teachings herein and, it is, therefore, desired to be secured in the appended claims all such modifications as fall within the true spirit and scope of the invention.

What is claimed is:

1. An apparatus for securing an object to a roof rack, said apparatus comprising:
a crossbar clamp for attaching said apparatus to a crossbar of said roof rack;
a securing arm; and
a settable rotational mechanism, attached to said securing arm to allow said securing arm to rotate about a rotational axis point, wherein said securing arm may rotate and be held in a closed position, such that said securing arm presses said object to said roof rack at a securing arm contact area.

2. The apparatus of claim 1 wherein said securing arm may be held in an open position.

3. The apparatus of claim 1 wherein said settable rotational mechanism is comprised of a clamping mechanism.

4. The apparatus of claim 1 wherein said settable rotational mechanism is comprised of a latching mechanism.

5. The apparatus of claim 1 wherein said settable rotational mechanism is comprised of a ratchet mechanism.

6. The apparatus of claim 5 wherein said securing arm is comprised of a compressible material at said securing arm contact area.

7. The apparatus of claim 6 wherein said securing arm contact area is at least a one inch line.

8. The apparatus of claim 7 wherein said securing arm has an upward curvature and a rounded tip.

9. The apparatus of claim 5 further comprising of a ratchet locking mechanism for preventing a release mechanism of said ratchet mechanism from allowing release.

10. The apparatus of claim 5 wherein said object is a surfboard.

11. The apparatus of claim 10 further comprising of a compressible pad between said surfboard and said crossbar.

12. The apparatus of claim 11 wherein said securing arm contact area is at a elevation higher than said rotational axis point.

13. The apparatus of claim 12 wherein said securing arm is detachably removable from said settable rotational mechanism.

14. An method for securing an object to a roof rack, comprising the step of:
attaching a securing apparatus to a crossbar of said roof rack;
placing said object on said crossbar adjacent to said securing apparatus;
rotating a securing arm, that is attached to a settable rotational mechanism of said apparatus, towards the closed position to press said object between said securing arm and said roof rack; and
holding said securing arm in the closed position by said settable rotational mechanism.

15. The method of claim 14 wherein said settable rotational mechanism holds said securing arm in the closed position through a clamping mechanism.

16. The method of claim 14 wherein said settable rotational mechanism holds said securing arm in the closed position through a latching mechanism.

17. The method of claim 14 wherein said settable rotational mechanism holds said securing arm in the closed position through a ratchet mechanism.

18. The method of claim 17 further comprising the step of locking said securing arm in the closed position through a ratchet locking mechanism.

19. The method of claim 18 wherein said securing arm is comprised of a compressible material at a securing arm contact area.

20. The method of claim 19 wherein said securing arm pressing said object provides both inward and downward force.
